(19) United States
(12) Patent Application Publication
(10) Pub. No.: US 2021/0191002 A1
(43) Pub. Date: Jun. 24, 2021

(54) SMALL CAMERA LENS WITH IMPROVED INTERNAL REFLECTION

(71) Applicant: SEKONIX CO., LTD., Dongducheon-si (KR)

(72) Inventors: Soon Cheol Choi, Namyangju-si (KR); Hyeoung Sok Ham, Uijeongbu-si (KR); Seung Nam Nam, Namyangju-si (KR); Jae Won Moon, Dongducheon-si (KR)

(21) Appl. No.: 17/125,525

(22) Filed: Dec. 17, 2020

(30) Foreign Application Priority Data
Dec. 19, 2019 (KR) 10-2019-0170503

(51) Int. Cl. G02B 5/00; G02B 3/04; B29D 11/00

(52) U.S. Cl. CPC G02B 5/003; B29D 11/00923; G02B 3/04

(57) ABSTRACT

Disclosed herein is a method for manufacturing a lens used for a camera, comprising forming a coating layer, by laminating at least one dielectric layer on an effective aperture portion of each of both surfaces of the lens, wherein the lens comprises the effective aperture portion, a flange portion and an outer aperture portion, and forming a colored layer, inside the surface of the lens, on at least a portion of the surface of the lens except the effective aperture portion on which the coating layer of the lens is formed, by making a black colored dye permeate through the pores of the surface after heating the lens to a temperature higher than a first temperature, and permeating the dye into the interior of the surface of the lens for coloring by lowering the temperature below the first temperature.

### CROSS-REFERENCE TO RELATED APPLICATIONS

This application claims the benefit of and priority to Korean Patent Application Serial No. 10-2019-0170503 filed Dec. 19, 2019, the disclosure of which is hereby incorporated by reference in its entirety.

### TECHNICAL FIELD

The present invention relates to a method for manufacturing a small camera lens with improved internal reflection and a camera lens manufactured according thereto. More specifically, the present invention relates to a method for manufacturing a lens for a camera, and a lens for a camera manufactured according thereto, forming a coating layer, by laminating at least one dielectric layer on an effective aperture portion of each of both surfaces of the lens, wherein the lens comprises the effective aperture portion, a flange portion and an outer aperture portion, and forming a colored layer inside the surface of the lens, on at least a portion of the surface of the lens except the effective aperture portion on which the coating layer of the lens is formed, by making a black colored dye permeate through the pores of the surface after heating the lens to a temperature higher than a first temperature, and making the dye permeate into the interior of the surface of the lens for coloring by lowering the temperature below the first temperature.

### BACKGROUND

As personal electronic products with a camera function such as smartphones are widely used, there has been an increasing demand for reducing the space occupied by the camera used in the products while securing the image quality of the camera, that is, for manufacturing a lens assembly used in a camera with better performances and a more compact size.

However, improving the performances of a lens assembly requires an elaborate assembling of a greater number of aspheric lenses having diverse refractive indices. For the purpose of achieving the goal of better performance, and a more compact size, of a lens assembly, lenses have become smaller and are optimized for assembly such that a structure such as a flange portion or an outer aperture portion has been added. For handling of the smaller lenses, processes for precise dimensional adjustment and assembly and the like are necessary.

However, using multiple compact aspheric lenses often causes phenomena such as flare and glare caused by the light entering a sensor via unintended paths in which the light traveling outside an effective aperture of a lens is reflected by a flange portion or an outer aperture portion to enter the effective aperture portion and reach the sensor, which causes the problem of image quality deterioration. More specifically, referring to FIG. 7, light 704 that enters via an unintended optical path in an aspheric lens having a flange portion 702 and an outer aperture portion 703 is reflected in the flange portion 702 and the outer aperture portion 703 to generate an undesired signal 705 to an image sensor on a side of the lens that is opposite to the side facing the light source.

In order to solve the problem, conventional technology adopts a method of directly blackening a portion of a flange portion of a lens. For example, in the method disclosed in PATENT DOCUMENT 1, a connection portion outside an effective aperture of a lens used for alignment comprises a coating area. More specifically, referring to FIG. 8, in PATENT DOCUMENT 1, the coating area 832 of the lens has a rough surface and a groove structure, and ink such as black resin is applied to the groove as the lens is rotated and then dried to form a black strip 862 outside the effective aperture of the lens. PATENT DOCUMENT 1 discloses an idea of blocking or absorbing unintended light and reducing internal reflection by taking advantage of the black coating area.

(PATENT DOCUMENT 1): U.S. Pat. No. 9,952,359B2 (Apr. 24, 2018)

### SUMMARY

### Problem to be Solved

However, the above-mentioned existing method of direct blackening by application of black ink or the like on a surface of a lens has restrictions of, for example, a limited shape of the lens or roughness of its surface to prevent the ink from encroaching upon the effective aperture.

Additionally, according to the method, only a portion of the flange can be blackened, and not all of the portions other that the effective aperture that light passes through are blackened, which leads to a problem of failing to absorb or block all optical paths because only some optical paths are absorbed or blocked.

Additionally, it is inconvenient to process a lens twice when blackening both surfaces of the lens.

Additionally, referring to FIG. 9, when the outer aperture portion 103 of a lens is blackened by applying ink 902 as in a conventional manner, the ink layer 903 applied to the outer aperture portion 103 is bound to flow down, such that it is impossible to blacken the outer aperture portion 103. This leads to a risk of light passing through or reflected by the portion of the lens that is not blackened. Further, the conventional method has a problem that a gate cutting portion created when a lens is produced by plastic injection molding or a side surface portion of a lens having an unusual shape such as a D-cut lens cannot be blackened, as in the case of the outer aperture portion 103.

Moreover, in case the blacking is made by application of ink, the ink layer 903 thus formed will have a certain thickness; then a layer with a certain thickness is formed on the surface of the lens, thereby interfering with precise assembly. In particular, precision of assembly is critical for a lens assembly structure that uses three or more lenses, where it is essential to arrange the lenses accurately, and the thickness caused by the blackening results in deterioration of performances of the lens.

### Means for Solving the Problem

As a means to solve the above-mentioned problems, a method for manufacturing a lens for a camera according to one aspect of the present disclosure comprises forming a coating layer, by laminating at least one dielectric layer on an effective aperture portion of each of both surfaces of the lens, wherein the lens comprises the effective aperture portion, a flange portion and an outer aperture portion, and forming a colored layer, inside the surface of the lens, on at least a portion of the surface of the lens except the effective aperture portion on which the coating layer of the lens is formed, by making a black colored dye permeate through the pores of the surface after heating the lens to a temperature higher than a first temperature, and making the dye permeate into the interior of the surface of the lens for coloring by lowering the temperature below the first temperature.

In an example, forming the colored layer may comprise making the dye permeate into all portions of the surfaces of the lens including the flange portion and the outer aperture portion except the effective aperture portions on which the coating layer of the lens is formed.

In another example, the coating layer may be an anti-reflective coating layer.

In another example, the effective aperture portion of the lens may have an aspheric shape.

In another example, the linear coefficient of thermal expansion of the dielectric layer may be lower than the linear coefficient of thermal expansion of the lens. Here, the linear coefficient of thermal expansion of the lens may be 5×10⁻⁵/° C. or higher, and the linear coefficient of thermal expansion of the dielectric layer may be 1×10⁻⁵/° C. or lower.

In another example, the method may comprise additionally laminating a dielectric layer on the surface of the lens after forming the colored layer.

In another example, the lens may comprise plastic, in particular at least one of PC (polycarbonate), COC (cyclo olefin copolymer) and COP (cyclo olefin polymer).

In another example, the outer aperture portion of the lens may comprise a gate cutting portion, and forming the colored layer may comprise making the dye permeate into the gate cutting portion as well, for coloring.

In another example, the lens may be a D-cut lens, and forming the colored layer may comprise making the dye permeate into the side surface portion of the D-cut lens as well, for coloring.

In another example, forming the colored layer may comprise immersing the lens in the dye. Here, forming the coating layer may comprise fixing the lens on a jig, wherein in the jig, there is a hole penetrated at a portion that corresponds to the effective aperture portion of the lens and the remaining portions are blocked, such that the hole can be placed on the effective aperture portion, and laminating the dielectric layer in a state where the lens is masked with the jig. Also, forming the colored layer may comprise immersing the lens in the dye in a state where the lens is fixed to the jig. Or, forming the colored layer may comprise immersing the lens in the dye after separating the lens from the jig. Here, immersing the lens in the dye after separating the lens from the jig may comprises immersing the lens in the dye after turning it over on a jig for coloring.

When immersing in the dye, the temperature of the dye may be 60° C. or higher and 90° C. or lower. In addition, immersing the lens in the dye may comprise immersing the lens in the dye for the period of 10 minutes or more and 60 minutes or less.

Additionally, forming the coating layer may comprise laminating a dielectric layer by vacuum deposition.

In another example, the transmittance of light in the wavelength range of the visible light region of the at least a portion of the lens on which the colored layer is formed according to the method may be 40% or lower, and the transmittance of light in the wavelength range of the visible light region of the portion of the lens on which the colored layer is not formed may be 90% or higher.

In another example, a lens assembly structure comprising a lens manufactured according to the aforementioned methods may be manufactured. Also, the lens assembly structure may comprise at least three lenses.

In a lens used for a camera according to another aspect of the present disclosure, a coating layer is formed by laminating at least one dielectric layer on an effective aperture portion of each of both surfaces of the lens, wherein the lens comprises the effective aperture portion, a flange portion and an outer aperture portion; and a colored layer is formed, inside the surface of the lens, on at least a portion of the surface of the lens except the effective aperture portion on which the coating layer of the lens is formed, by making a black colored dye permeate through the pores of the surface after heating the lens to a temperature higher than a first temperature, and making the dye permeate into the interior of the surface of the lens for coloring by lowering the temperature below the first temperature.

In an example, all portion of the surface of the lens including the flange portion and the outer aperture portion except the effective aperture portion on which the coating layer of the lens is formed may be permeated, and colored, with a dye.

In another example, the coating layer may be an anti-reflective coating layer.

In another example, the effective aperture portion of the lens may have an aspheric shape.

In another example, the linear coefficient of thermal expansion of the dielectric layer may be lower than the linear coefficient of thermal expansion of the lens.

In another example, the linear coefficient of thermal expansion of the lens may be 5×10⁻⁵/° C. or higher, and the linear coefficient of thermal expansion of the dielectric layer may be 1×10⁻⁵/° C. or lower.

In another example, the lens may comprise at least one of PC (polycarbonate), COC (cyclo olefin copolymer) and COP (cyclo olefin polymer).

In another example, the outer aperture portion of the lens may comprise a gate cutting portion, and the gate cutting portion may be permeated, and colored, with a dye.

In another example, the lens may be a D-cut lens, and a side surface portion of the D-cut lens may be permeated, and colored, with a dye.

In another example, the transmittance of light in the wavelength range of the visible light region of the at least a portion of the lens on which the colored layer is formed may be 40% or lower, and the transmittance of light in the wavelength range of the visible light region of the portion of the lens on which the colored layer is not formed may be 90% or higher.

In another example, a lens assembly structure comprising the aforementioned lenses may be disclosed. Also, the lens assembly structure may comprise at least three lenses.

### Effect of the Invention

According to the method for manufacturing a lens according to the present disclosure and the lens manufactured according thereto, a coating layer is formed by laminating at least one dielectric layer on an effective aperture portion of a lens, and the coating layer acts as a mask against the dye and as such, black dye permeates only the portion of the lens on which the coating layer is not formed, thereby allowing easy formation of a colored layer inside the surface of the lens except the effective aperture portion.

Additionally, since not just a portion of the flange portion but also all the other portions than the effective aperture portion can be blackened, light that enters via unintended optimal paths can be effectively absorbed to prevent occurrence of internal reflection.

Moreover, only one processing is required when both surfaces of a lens are processed, which is advantageous in terms of both cost and time.

Further, a colored layer can be formed easily on the outer aperture portion of the lens. In addition, because a colored layer can be formed regardless of the shape of the lens, the colored layer can be formed easily even when the lens comprises a gate cutting portion or has a side surface portion, because it has an unusual shape such as the shape of a D-cut lens.

Additionally, because a dye permeate into the lens for coloring, it does not affect the thickness of the lens; thus, it does not interfere with precise assembly of a lens assembly structure even when the colored layer is formed.

Moreover, because there are boundaries set as a coating layer on the lens in advance, a colored layer can be formed with higher precision than in a process of simply applying ink.

### BRIEF DESCRIPTION OF THE DRAWINGS

FIG. 1A is a drawing showing the structure of a lens used in some examples.

FIG. 1B is a flowchart of a method for manufacturing a camera lens according to some examples.

FIGS. 2A and 2B are drawings that explain the principle of permeation and coloring used in the present disclosure.

FIG. 3A is a drawing of a jig used to manufacture a lens according to some example.

FIG. 3B is a cross-sectional view of a portion of a jig as seen from a side according to some example.

FIG. 4 is a drawing showing a method for processing a lens using a jig according to some example.

FIG. 5A are drawings comparing a lens as seen from a side before it was processed according to an example of the present disclosure with a lens as seen from a side after it was processed according to an example of the present disclosure.

FIG. 5B are drawings comparing a lens as seen from above before it was processed according to an example of the present disclosure with a lens as seen from above after it was processed according to an example of the present disclosure.

FIG. 6A is a drawing showing a gate cutting portion.

FIG. 6B is a drawing showing a D-cut lens.

FIG. 7 is a drawing showing an exemplary optical path causing internal reflection.

FIG. 8 is a drawing showing conventional technology.

FIG. 9 is a drawing showing a problem of conventional technology.

### DETAILED DESCRIPTION

Hereinafter, examples according to the present disclosure are described in further detail with reference to the drawings. The following examples are only for illustrating the examples and not intended to limit or restrict the scope of the present disclosure. What a person skilled in the technical field to which the present disclosure pertains can easily infer from the detailed description and examples of the invention disclosure should be construed as belonging to the scope of the present disclosure.

The terms used in the present disclosure are general terms widely used in the technical field of the present disclosure, but the meanings of the terms used in the present disclosure may vary depending on the intention of a skilled person in the pertinent field, precedents, emergence of new technology, or the like. Some terms may be selected by the applicant as desired, in which case the meanings of the terms will be described in detail. Terms used in the present disclosure should be construed to have meanings in light of the overall context of the specification, not just literal meanings.

The terms of ‘comprise’ and ‘include’ used in the present disclosure should not be construed to necessarily include all the constituents or steps described in the specification, but they should be construed to include a case that some of the constituents or steps are not included and a case that additional constituents or steps are further included.

The terms including an ordinal number such as ‘first’ or ‘second’ used in the present disclosure may be used to explain various constituents or steps, but the constituents or steps should not be limited by the ordinal numbers. A term including an ordinal number should be construed to be intended only to distinguish a constituent or step from another constituent or step.

Hereinafter, examples according to the present disclosure are described in detail with reference to the drawings. Detailed descriptions of matters widely known to those skilled in the technical field to which the present disclosure pertains are omitted.

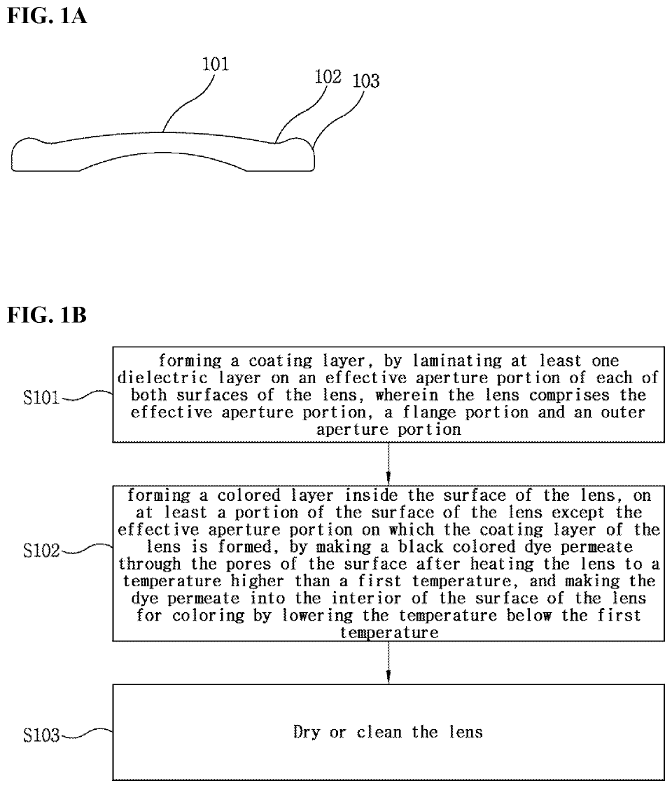

FIG. 1A shows the structure of a lens used in some examples.

Referring to FIG. 1A, the lens comprises an effective aperture portion 101 through which light passes, a flange portion 102 for fixing the lens, and an outer aperture portion 103 that is an edge portion of the lens. By comprising these structures, the lens can be arranged in an easy and stable manner, which allows precise adjustment of distance and the like.

FIG. 1B is a flowchart of a method for manufacturing a camera lens according to some example.

Referring to FIG. 1B, according to some example, a coating layer may be formed by laminating at least one dielectric layer on an effective aperture portion 101 of each of both surfaces of a lens comprising the effective aperture portion, a flange portion 102 and an outer aperture portion 103 (S101). Then, the lens is heated to a temperature higher than a first temperature and then, black colored dye permeates through the pores of a surface and then the temperature is lowered to the first temperature or below, so that it is possible to making the dye permeate into at least a portion of the surface of the lens except the effective aperture portion 101 on which the coating layer of the lens is formed. Here, the first temperature may be room temperature. Room temperature may be a temperature between 20° C. and 30° C. In addition, the lens may be permeated with the dye at the same time as the heating of the lens. Or, the first temperature may be a temperature between 0° C. and 60° C. However, the range of the first temperature is not limited to the above-mentioned examples and may include other temperature ranges. Then, the lens may be dried or cleaned S103. Accordingly, the coating layer acts as a mask on the dye, and thus, the black colored dye permeates only the portion of the lens on which the coating layer is not formed, which allows easy formation of the colored layer inside the surface of the lens except the effective aperture portion 101.

In another example, in step S102, all portions of the surface of the lens including the flange portion 102 and the outer aperture portion 103, except for the effective aperture portion 101 on which the coating layer of the lens is formed, may be permeated, and colored, with the dye. Through this, light that does not pass through the effective aperture portion is absorbed to stop light entered by unintended paths from passing through the lens, thereby effectively preventing occurrence of internal reflection.

In yet another example, a coating layer formed by laminating at least one dielectric layer on the lens may be an anti-reflective coating layer. Since the anti-reflective coating layer is formed on the effective aperture portion 101, it restricts the reflection of light that enters or comes out the effective aperture portion 101. This restricts introduction of light via unwanted paths, to more effectively prevent occurrence of internal reflection.

In yet another example, the effective aperture portion 101 of the lens may have an aspheric shape. For example, they may have a shape according to an aspheric equation with high order coefficients, such as the one disclosed in Korean Patent No. 10-1425780.

In another example, forming a coating layer by laminating at least one dielectric layer (S101) may comprise laminating at least one dielectric layer by vacuum deposition where deposition material is vaporized or sublimated in vacuum by a heating device to be deposited on an object. In addition, the dielectric layer may comprise, for example, at least one of SiO₂, Al₂O₂ and TiO₂, but is not limited thereto, and it may comprise other known components of a dielectric layer.

The surface of a lens manufactured according to the present disclosure may be smooth surface with low surface roughness or rough surface with high surface roughness but is not limited thereto.

In a lens assembly structure formed of multiple lenses, each lens may be designed to have a different refractive index and, to this end, different materials may be used for different lenses.

In another example, the lens may comprise plastic. More specifically, the lens may consist of one of PC (polycarbonate), COC (cyclo olefin copolymer) and COP (cyclo olefin polymer) or comprise at least one of them. In particular, a PC material with a relatively high refractive index or a COC or COP material with a relatively low refractive index may be used, but it is not limited thereto and may use another known plastic material.

In another example, the method according to the present disclosure may comprise additionally laminating a dielectric layer on the surface of the lens after forming a colored layer S102. Accordingly, an additional process to improve the performance of the lens can be carried out even after the formation of the colored layer.

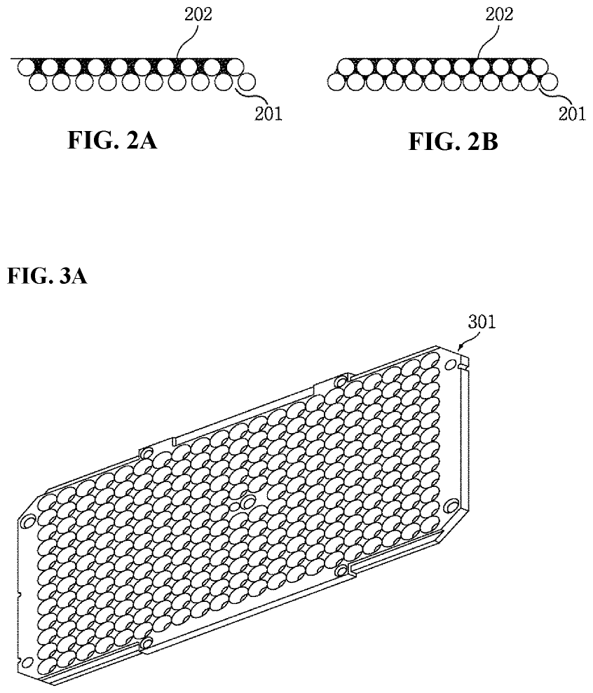

FIGS. 2A and 2B explain, in further detail, the principle of permeation for coloring according to the present disclosure.

FIG. 2A shows dye 202 as applied when a particular material 201 is heated up. More specifically, since material 201, upon being heated, would expand due to the heat, the space between the molecules of the material 201 widens to open the pores. When the dye 202 is applied at this point, the dye 202 permeates through the pores of the material 201. FIG. 2B shows material 201 where the temperature has dropped after dye 202 was applied to it in a state where it was heated. If the temperature is lowered to, for example, room temperature in the state where the material 201 is permeated with the dye 202, it causes the expanded material 201 to shrink, but then, the dye 202 has already permeated through the pores of the material 201. That is, the temperature is lowered while the dye 202 has permeated and colored the inside of the material 201, as shown in FIG. 2B.

However, if the material 201 has a low linear coefficient of thermal expansion, the dye 202 may not permeate the material, because the pores do not open sufficiently. For this reason, even when the dye is applied after heating materials having different linear coefficients of thermal expansion at the same temperature, the dye 202 may permeate and color only the surface of the material having a high linear coefficient of thermal expansion, thereby forming a colored layer inside the surface, and the dye 202 may not permeate the surface of the material having a low linear coefficient of thermal expansion, failing to form a colored layer.

Accordingly, in another example, the linear coefficient of thermal expansion of the dielectric layer may be lower than the linear coefficient of thermal expansion of the lens. In particular, the linear coefficient of thermal expansion of the dielectric layer may be lower than the linear coefficient of thermal expansion of the portion of the lens on which a colored layer is formed. Accordingly, even when the dye 202 is applied after the coating layer consisting of at least one dielectric layer is heated together with the lens, only the portion of the lens on which a colored layer is to be formed is colored with the dye 202, without coloring the coating layer, to prevent interference with the light passing through the effective aperture portion. In addition, for example, the linear coefficient of thermal expansion of the lens may be 5×10⁻⁵/° C. or higher and 5×10⁻⁴/° C. or lower, and the linear coefficient of thermal expansion of the dielectric layer may be 1×10⁻⁷/° C. or higher and 1×10⁻⁵/° C. or lower.

In another example, forming the colored layer (S102) may comprise immersing the lens in the dye 202. Accordingly, it makes it easy for the dye to permeate all portions of the surfaces of the lens including the flange portion 102 and the outer aperture portion 103 except for the effective aperture portion 101, where the coating layer acts as a mask to prevent the permeation of the dye.

In another example, the temperature of the dye 202 may be 60° C. or higher and 90° C. or lower. Accordingly, it is possible to heat the lens to a temperature higher than the first temperature, which is room temperature for example, when forming the colored layer without a separate device or process S102.

In another example, immersing the lens in the dye 202 may comprise immersing the lens in the dye 202 for the period of 10 minutes or more and 60 minutes or less. By immersing the lens in the dye 202 for the period of 10 minutes or more, the colored layer may be easily formed inside and, by immersing the lens in the dye 202 for the period of 60 minutes or less, it is possible to prevent the dye 202 from being laminated to form an unnecessary layer on the surface of the lens.

The dye 202 used in the present disclosure may have a color that absorbs light in the wavelength range of the visible light region. For example, it may be blue, red, yellow, orange, or violet. Here, the wavelength range of the visible light region may be a range of 400 nm or higher and 700 nm or lower. In an example, the color of the dye 202 may be black.

Additionally, the dye may be a disperse dye and may be obtained by mixing dyes of various colors. For example, a disperse dye may be obtained by mixing the following five categories of dyes.

(1) Blue Dyes:

Dianix Blue AC-E, Dianix Blue RNE (C.I. Disperse Blue 91), Dianix Blue GRE (C.I. Disperse Blue 81), Sumikaron Blue E-R (C.I. Disperse Blue 91), and Kayaron Polyester Blue GR-E (C.I. Disperse Blue 81)

(2) Red Dyes:

Dianix Red AC-E, Diaceliton Fast Red R (C.I. Disperse Red 17), Diaceliton Fast Scarlet R (C.I. Disperse Red 7), Diaceliton Fast Pink R (C.I. Disperse Red 4), Sumikaron Rubin SE-RPD, and Kayaron Polyester Rubin GL-SE200 (C.I. Disperse Red 73)

(3) Yellow Dyes:

Dianix Yellow AC-E, Dianix Yellow YL-SE (C.I. Disperse Yellow 42), Sumikaron Yellow SE-RPD, Diaceliton Fast Yellow GL (C.I. Disperse Yellow 33), Kayaron Fast Yellow GL (C.I. Dis Perth Yellow 33), and Kayaron Microester Yellow AQ-LE

(4) Orange Dyes:

Dianix Orange B-SE200 (C.I. Disperse Orange 13), Diaceliton Fast Orange GL (C.I. Disperse Orange 3), Miketon Polyester Orange B (C.I. Disperse Orange 13), Sumikaron Orange SE-RPD, and Sumikaron Orange SE-B (C.I. Disperse Orange 13)

(5) Violet Dyes:

Dianix Violet 5R-SE (C.I. Disperse Violet 56) and Sumikaron Violet E-2RL (C.I. Disperse Violet 28).

In another example, the transmittance of light in the wavelength range of the visible light region of the at least a portion of the lens on which the colored layer is formed by step of forming a colored layer (S102) may be 40% or lower, and the transmittance of light in the wavelength range of the visible light region of the portion of the lens on which the colored layer is not formed may be 90% or higher. Here, the method for measuring the transmittance of light in the wavelength range of the visible light region may be by measuring the ratio of the intensity of the incident light after the light in the wavelength range of the visible light region has been projected to the intensity of the projected light over the entire wavelength range of the visible light region. If the transmittance of the light in the entire wavelength range of the visible light region is at a particular level or higher, it can be said that the transmittance of the light in the wavelength range of the visible light region is equal to or higher than the particular level. If the transmittance of the light in the entire wavelength range of the visible light region is at a particular level or lower, it can be said that the transmittance of the light in the wavelength range of the visible light region is equal to or lower than the particular level.

In another example, forming the coating layer (S101) may comprise fixing the lens on a jig, wherein in the jig, there is a hole penetrated at a portion that corresponds to the effective aperture portion (101) of the lens and the remaining portions are blocked, such that the hole can be placed on the effective aperture portion (101), and laminating the dielectric layer in a state where the lens is masked with the jig.

In this regard, FIG. 3A shows a jig 301 used to manufacture a lens according to some example, and FIG. 3B is a cross-sectional view of a portion of the jig 301.

Referring to FIGS. 3A and 3B, the jig 301 may fix multiple lenses and has a hole only at a portion corresponding to the effective aperture portion 101 of the lens. This allows processing of multiple lenses at the same time. In addition, since the jig 301 masks the portions other than the effective aperture portion 101 of a lens, when a process is performed to laminate a dielectric layer on the lens in the state where the lens is fixed to the jig 301, a coating layer can be formed by laminating the dielectric layer only on the effective aperture portion 101 on which the coating layer needs to be formed with high precision.

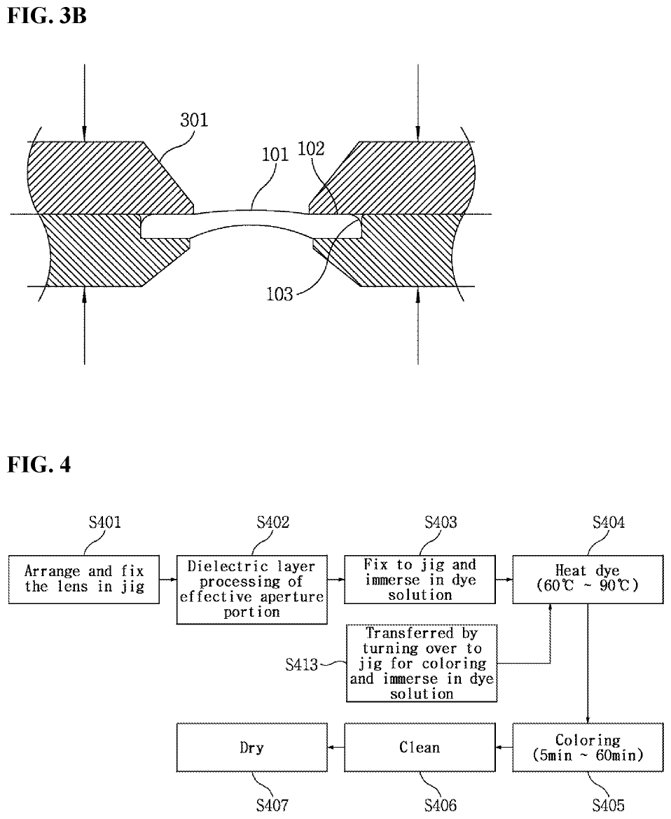

FIG. 4 shows a method for processing a lens using a jig 301 according to some example.

Referring to FIG. 4, the coating layer may be formed by first arranging and fixing the lens in the jig 301 (S401) and laminating the dielectric layer only on the effective aperture portion 101 of the lens by, for example, a method such as vacuum deposition mentioned earlier (S402).

According to an example, after a coating layer is formed by laminating a dielectric layer, the lens may be immersed in the dye 202 S403 as it is fixed to the jig 301. Here, while the jig 301 fixes the lens, it is not that it is attached to the lens without any gap therebetween. As such, even when the lens is immersed as fixed to the jig 301, it can be permeated and colored after the dye 202 is applied to the surface of the lens, particularly the flange portion 102 and the outer aperture portion 103.

According to yet another example, after a coating layer is formed by laminating a dielectric layer, the lens may be separated from the jig 301 and immersed in the dye 202. Here, a jig for coloring that is different from the jig used for laminating the dielectric layer may be used. Since the coating layer has already been formed on the lens, the jig for coloring can be of any shape as long as it allows fixing of the lens in the dye 202, and it is not particularly limited. In another example, the lens at the jig 302 used for laminating the dielectric layer on the lens may be turned over, transferred to the jig for coloring, and immersed in the dye 202 (S413).

Heating the dye 202 before immersing the lens in the dye 202 is allowed, and it is also allowed to heat the dye 202 after immersing the lens in the dye 202 as shown in FIG. 4 (S404). Then, the lens may be immersed in the dye 202 for a predetermined period S405, cleaned (S406), and dried (S407).

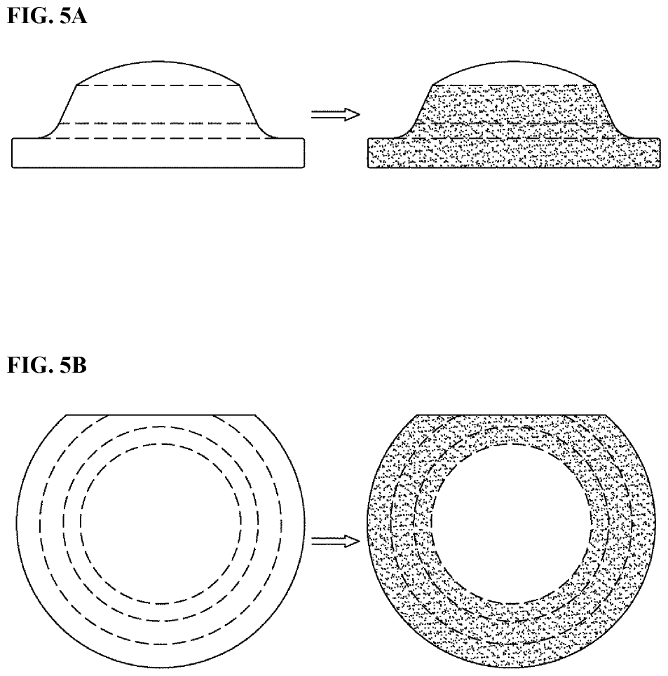

FIG. 5A are drawings comparing a lens (left one) as seen from a side before it was processed according to an example of the present disclosure with a lens (right one) as seen from a side after it was processed according to an example of the present disclosure. FIG. 5B are drawings comparing a lens (left one) as seen from above before it was processed according to an example of the present disclosure with a lens (right one) as seen from above after it was processed according to an example of the present disclosure. It can be understood that, in a lens manufactured according to an example of the present disclosure, the colored layer is formed on the portion other than the effective aperture portion 101. While the light passing through the lens without the colored layer will be reflected internally, the lens manufactured according to an example of the present disclosure where the colored layer is formed on the surface of the lens that is not used optically will not suffer internal reflection of the light passed through the lens.

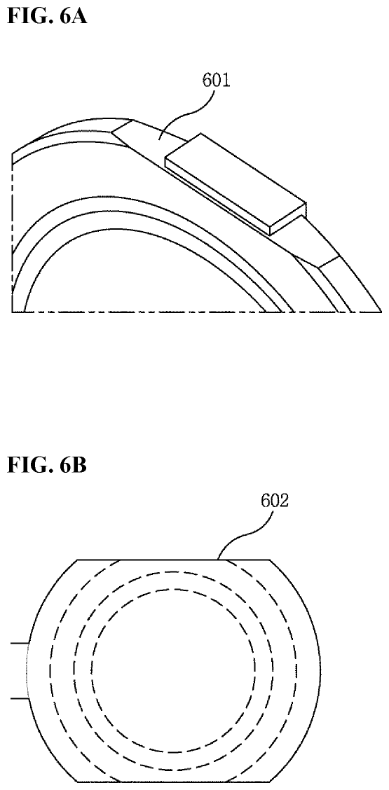

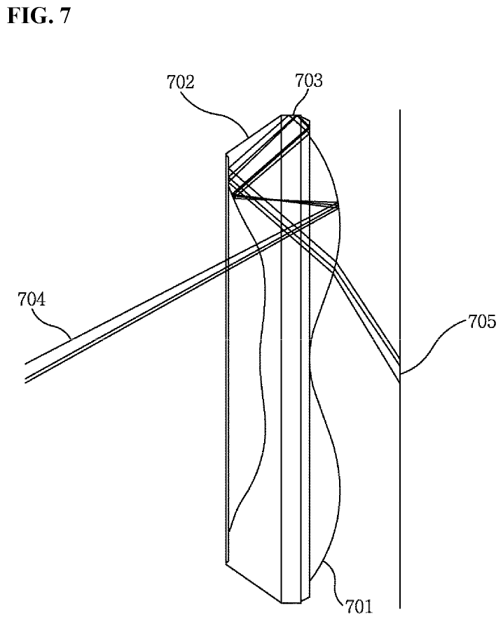

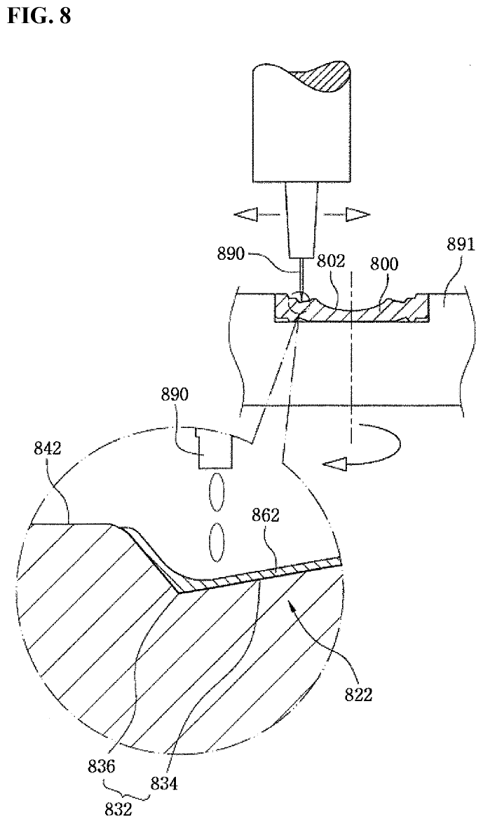

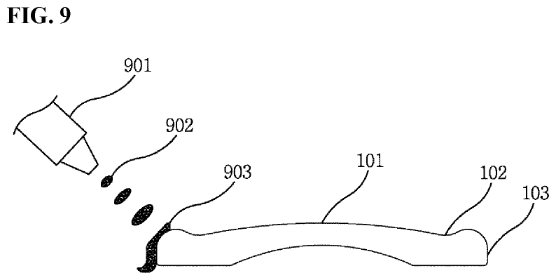

FIG. 6A shows a gate cutting portion 601. In case of a lens manufactured by plastic injection molding, plastic is injected and cut to manufacture a lens, in which case, the outer aperture portion 103 of the lens may comprise a portion that is cut, i.e., a gate cutting portion 601. FIG. 6B shows a D-cut lens. For the purpose of, for example, making a lens compact, a portion of a lens may be cut off, and the lens may have a side surface portion 602 as a result.

In another example, because the method for manufacturing a lens according to the present disclosure is not restricted by the shape of the lens, even when the lens has a gate cutting portion 601 or a side surface portion 602 because it is a D-cut lens, the gate cutting portion 601 or the side surface portion 602 of the D-cut lens may be permeated with a dye 202 to form a colored layer.

In another example, a lens assembly structure comprising a lens manufactured by the methods disclosed above may be manufactured. Here, the lens assembly structure may comprise at least three lenses. When a lens manufactured by a method for manufacturing a lens according to the present disclosure is used in a lens assembly structure comprising multiple lenses, a colored layer is formed inside the lens, such that it does not affect the thickness of the lens, thereby allowing precise assembly of the lens assembly structure to achieve intended excellent performance of the lens assembly structure.

A lens manufactured by a method for manufacturing according to the present disclosure may be used for a camera. For example, it may be used for a smartphone camera, an ordinary camera, a camera for automobiles, or the like, but is not limited thereto and may be used for any camera.

While the examples are described in detail above, the scope of the present disclosure is not limited thereto, and various modifications and improvements by skilled persons in the art using the basic ideas of the present disclosure described in the following claims are also included in the scope of the present disclosure.

What is claimed is:

1. A method for manufacturing a lens used for a camera, comprising,
forming a coating layer, by laminating at least one dielectric layer on an effective aperture portion of each of both surfaces of the lens, wherein the lens comprises the effective aperture portion, a flange portion and an outer aperture portion, and
forming a colored layer, inside the surface of the lens, on at least a portion of the surface of the lens except the effective aperture portion on which the coating layer of the lens is formed, by making a black colored dye permeate through the pores of the surface after heating the lens to a temperature higher than a first temperature, and making the dye permeate into the interior of the surface of the lens for coloring by lowering the temperature below the first temperature.

2. The method for manufacturing a lens used for a camera according to claim 1,
wherein forming the colored layer comprises making the dye permeate into all portions of the surfaces of the lens including the flange portion and the outer aperture portion except the effective aperture portions on which the coating layer of the lens is formed.

3. The method for manufacturing a lens used for a camera according to claim 1,
wherein the coating layer is an anti-reflective coating layer.

4. The method for manufacturing a lens used for a camera according to claim 1,
wherein the effective aperture portion of the lens has an aspheric shape.

5. The method for manufacturing a lens used for a camera according to claim 1,
wherein the linear coefficient of thermal expansion of the dielectric layer is lower than the linear coefficient of thermal expansion of the lens.

6. The method for manufacturing a lens used for a camera according to claim 5,
wherein the linear coefficient of thermal expansion of the lens is 5×10⁻⁵/° C. or higher, and the linear coefficient of thermal expansion of the dielectric layer is 1×10⁻⁵/° C. or lower.

7. The method for manufacturing a lens used for a camera according to claim 1, comprising
additionally laminating a dielectric layer on the surface of the lens after forming the colored layer.

8. The method for manufacturing a lens used for a camera according to claim 1,
wherein the lens comprises at least one of PC (polycarbonate), COC (cyclo olefin copolymer) and COP (cyclo olefin polymer).

9. The method for manufacturing a lens used for a camera according to claim 1,
wherein the outer aperture portion of the lens comprises a gate cutting portion, and forming the colored layer comprises making the dye permeate into the gate cutting portion as well, for coloring.

10. The method for manufacturing a lens used for a camera according to claim 1,
wherein the lens is a D-cut lens, and
forming the colored layer comprises making the dye permeate into the side surface portion of the D-cut lens as well, for coloring.

11. The method for manufacturing a lens used for a camera according to claim 1,
wherein forming the colored layer comprises immersing the lens in the dye.

12. The method for manufacturing a lens used for a camera according to claim 11,
wherein forming the coating layer comprises
fixing the lens on a jig, wherein in the jig, there is a hole penetrated at a portion that corresponds to the effective aperture portion of the lens and the remaining portions are blocked, such that the hole can be placed on the effective aperture portion and
laminating the dielectric layer in a state where the lens is masked with the jig.

13. The method for manufacturing a lens used for a camera according to claim 12,
wherein forming the colored layer comprises immersing the lens in the dye in a state where the lens is fixed to the jig.

14. The method for manufacturing a lens used for a camera according to claim 12,
wherein forming the colored layer comprises immersing the lens in the dye after separating the lens from the jig.

15. The method for manufacturing a lens used for a camera according to claim 14,
wherein immersing the lens in the dye after separating the lens from the jig comprises immersing the lens in the dye after turning the lens over and arranging it on a jig for coloring.

16. The method for manufacturing a lens used for a camera according to claim 11,
wherein the temperature of the dye is 60° C. or higher and 90° C. or lower.

17. The method for manufacturing a lens used for a camera according to claim 11,
wherein immersing the lens in the dye comprises immersing the lens in the dye for the period of 10 minutes or more and 60 minutes or less.

18. The method for manufacturing a lens used for a camera according to claim 1,
wherein forming the coating layer comprises laminating a dielectric layer by vacuum deposition.

19. The method for manufacturing a lens used for a camera according to claim 1,
wherein the transmittance of light in the wavelength range of the visible light region of the at least a portion of the lens on which the colored layer is formed according to the method is 40% or lower, and the transmittance of light in the wavelength range of the visible light region of the portion of the lens on which the colored layer is not formed is 90% or higher.

20. A lens used for a camera,
wherein a coating layer is formed by laminating at least one dielectric layer on an effective aperture portion of each of both surfaces of the lens, wherein the lens comprises the effective aperture portion, a flange portion and an outer aperture portion; and
a colored layer is formed, inside the surface of the lens, on at least a portion of the surface of the lens except the effective aperture portion on which the coating layer of the lens is formed, by making a black colored dye permeate through the pores of the surface after heating the lens to a temperature higher than a first temperature, and making the dye permeate into the interior of the surface of the lens for coloring by lowering the temperature below the first temperature.
